(19) United States
(12) Patent Application Publication
(10) Pub. No.: US 2014/0334635 A1
(43) Pub. Date: Nov. 13, 2014

(54) 7GHz Professional Wireless Microphone System

(71) Applicant: Broadcast Sports Incorporated, Hanover, MD (US)

(72) Inventors: Peter Larsson, Annapolis, MD (US); Sacha Jerome Rossek, Middlesex (GB)

(21) Appl. No.: 13/890,331

(22) Filed: May 9, 2013

(51) Int. Cl. H04H 60/90

(52) U.S. Cl. CPC H04H 60/90
USPC 381/77

(57) ABSTRACT

A wireless microphone system for the transmission and reception of high fidelity analog or digital audio information uses the 7 GHz frequency spectrum. In particular, the system has ultra-low latency and is capable of being used within existing receiver infrastructure allocated to program making and special events (PMSE). The system incorporates packet diversity in order to provide wider area coverage than conventional wireless microphone systems.

### BACKGROUND OF THE INVENTION

The present invention concerns an ultra-low latency wireless microphone operating within the 7 GHz frequency spectrum, with primary use for program making and special events (PMSE). The wireless microphone integrates within current broadcast infrastructure as used for wireless camera video systems, or it may be used as a standalone wireless microphone system for live events.

### BRIEF DESCRIPTION OF THE PRIOR ART

Professional wireless microphones predominately operate within the ultra-high frequency (UHF) spectrum, typically over the frequency range 440-790 MHz. Working within this part of the spectrum poses a number of operational limitations as described below.

UHF spectrum is shared with many other wireless systems. At medium or large broadcast events, this spectrum becomes extremely congested and requires intense co-ordination to avoid interference issues.

As the allowable occupied bandwidth for a wireless microphone channel in the UHF spectrum is limited to around 100-200 kHz, this implies that for high quality digital audio transmission, compression techniques must be applied. Most audio compression techniques, such as MPEG, introduce time delays that are not desirable for live events.

Some wireless microphone systems have used multi-level modulation techniques to permit the transmission of digital audio within the bandwidth of a UHF channel. Such implementations have an unfavorable impact on the wireless link and the efficiency of the microphone transmitter.

Wireless camera systems, used to relay video images for live broadcast events, have recently transitioned from 2 GHz spectrum to 7 GHz. As a result, infrastructure is now available and already deployed to receive and process information over this frequency range. A 7 GHz wireless microphone would be able to use this common infrastructure which would simplify and subsequently reduce operational costs associated with live broadcast events.

At large broadcast events multiple receive locations must be deployed to provide reliable wireless coverage. Wireless camera systems employ packet diversity techniques to allow automatic and seamless transfer between different receive locations. Current UHF based wireless microphone systems have to be manually switched. Using the same infrastructure will allow for package diversity techniques to be applied in a wireless microphone system.

The present invention was developed in order to overcome these and other drawbacks of prior wireless transmission systems by providing a 7 GHz wireless microphone system.

### SUMMARY OF THE INVENTION

Accordingly, it is a primary object of the present invention to provide a wireless microphone system which operates over the 7 GHz spectrum and which has ultra-low latency and employs package diversity to permit the use of multiple receive sites for wide area coverage. A particular property of the invention is that by operating at higher frequencies than traditional UHF wireless microphone systems, the usual limitations of spectrum congestion, frequency allocation, bandwidth limitation and latency are overcome.

### BRIEF DESCRIPTION OF THE FIGURES

Other objects and advantages of the invention will become apparent from a study of the following specification when viewed in the light of the accompanying drawings, in which:

FIG. 1 is a block diagram of a 7 GHz wireless microphone transmitter according to the invention;

FIG. 2 is a block diagram of a 7 GHz diversity wireless microphone down-converter according to the invention;

FIG. 3 is a block diagram of a wireless microphone receiver according to the invention; and

FIG. 4 is a block diagram of a package diversity receiver according to the invention.

### DETAILED DESCRIPTION

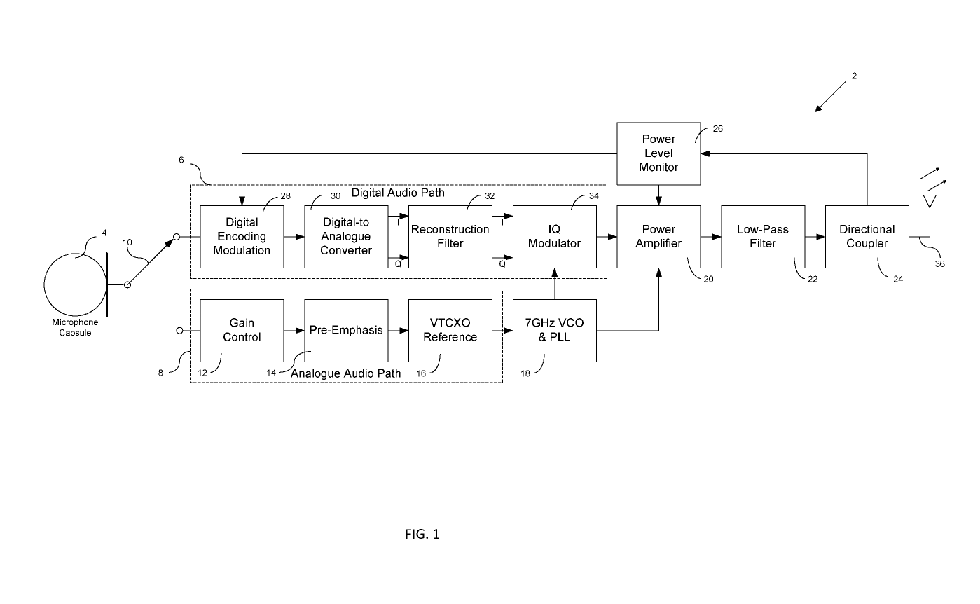

In accordance with the present invention, the components of a handheld, battery powered microphone transmitter 2 are shown in FIG. 1. Since each country allocates different frequencies for wireless broadcast links, the transmitter is capable of operating over a wide frequency range, 6.0-8.0 GHz, to allow usage worldwide. The transmitter interfaces with a professional microphone capsule 4 which provides power to the capsule and an analog audio input to the transmitter unit.

There are different opinions regarding the use of digital techniques in relation to audio fidelity. Accordingly, the transmitter includes digital 6 or analog 8 audio processing paths that are selectable by the program maker via a switch 10. In the analog path 8, a gain control device 12 and a pre-emphasis device 14 are applied in a conventional manner and the resultant analog signal is used to directly modulate a voltage controlled, temperature stable reference oscillator (VTCXO) 16. A high frequency voltage controlled oscillator (VCO) and phase locked loop (PLL) combination 18 is phase locked to the modulated VTCXO 16 using a frequency synthesizer. The frequency modulated (FM) VCO output is then amplified by an amplifier 20 and filtered by a filter 22 prior to transmission. A 1/16^{th} wavelength microstrip directional coupler 24 and a power level monitor circuit 26 are used to maintain a stable transmission power by dynamically adjusting the gain of the amplifier 20.

If the digital audio path 6 is selected, then the audio signal must be digitized by a digital encoding modulation device 28, at which stage error correction, interleaving, non-linear companding and auxiliary information may be added to enhance the performance of the audio and wireless link Digital modulation is applied to a digital to analog converter (DAC) 30 which generates in-phase (I) and quadrature phase (Q) signals. A reconstruction filter 32 removes DAC alias frequencies, while an IQ modulator 34, driven by the high frequency VCO 18, directly up-converts the IQ signals to 7 GHz. The output of the IQ modulator 34 is then amplified by the amplifier 20 and filtered by the filter 22 using common components to the analog path. The directional coupler 24 and power level monitor 26 are used to maintain a stable transmit power by dynamically scaling the modulation level in the digital domain encoding modulation device. Finally, a bi-conical antenna element 36 is used as a wideband omni-directional radiating element.

Since current professional wireless microphone transmitters operating in the UHF band are channel bandwidth limited to around 200 kHz, and digitized audio suitable for professional use typically requires >1 Mbit/s, some form of audio compression and/or multi-level modulation must be applied. Audio compression techniques such as MPEG introduce time delays which are undesirable for live broadcasting. The use of multi-level modulation (e.g., 16-QAM) will have a detrimental impact on the robustness of the wireless link and furthermore, on the efficiency of the active radio frequency (RF) components in the transmitter chain due to the envelope of the modulation not being constant. By operating at higher frequencies, the channel bandwidth limitations are relaxed and the transmission of uncompressed audio is achievable. One drawback to use of higher frequencies is the reduction in the range of the wireless link and the increased occurrence of fading due to reflections and multi-path effects. These shortcomings are mitigated through the use of receive infrastructure incorporating spatial and packet diversity, which also form part of the present invention.

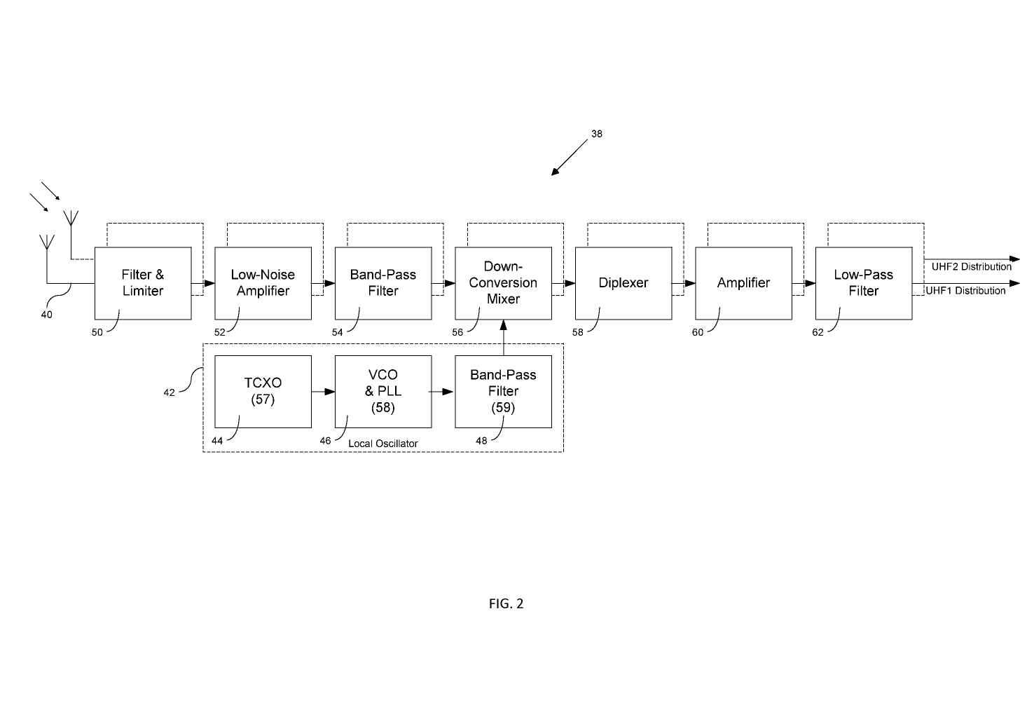

A dual diversity down-converter 38 is shown in FIG. 2. It is used to receive and transfer the 7 GHz wireless microphone transmissions to UHF spectrum, at which stage the UHF signals may be integrated into already available distribution and receive infrastructure. The down-converter is also suitable for the reception of wireless video transmissions, commonly deployed at broadcast events. The down-converter includes two receive antennas 40 that are physically separated to provide spatial diversity in order to counteract channel fading issues. The down-converter is a wide-IF architecture in which a local oscillator 42 is at a fixed frequency and is supplied to both down-converter chains. The local oscillator is generated by phase locking a high frequency VCO 46 to a temperature stable reference oscillator (TCXO) 44 whose output is delivered to a band-pass filter 48. The received signals from the antennae 40 are passed through a 7 GHz band-pass filter and limiter 50 which provides protection against damage or overload from high-level transmissions. The receive signal is amplified by an amplifier 52 and further filtered by a filter 54 prior to delivery to a down-conversion mixer 56 which mixes the receive signal with the output from the local oscillator 42 and converts the 7 GHz signals to UHF. A diplexer 58 is used to filter unwanted mixing components and reduce reciprocal mixing. The UHF signal is further amplified by an amplifier 60 and filtered by a filter 62 prior to distribution.

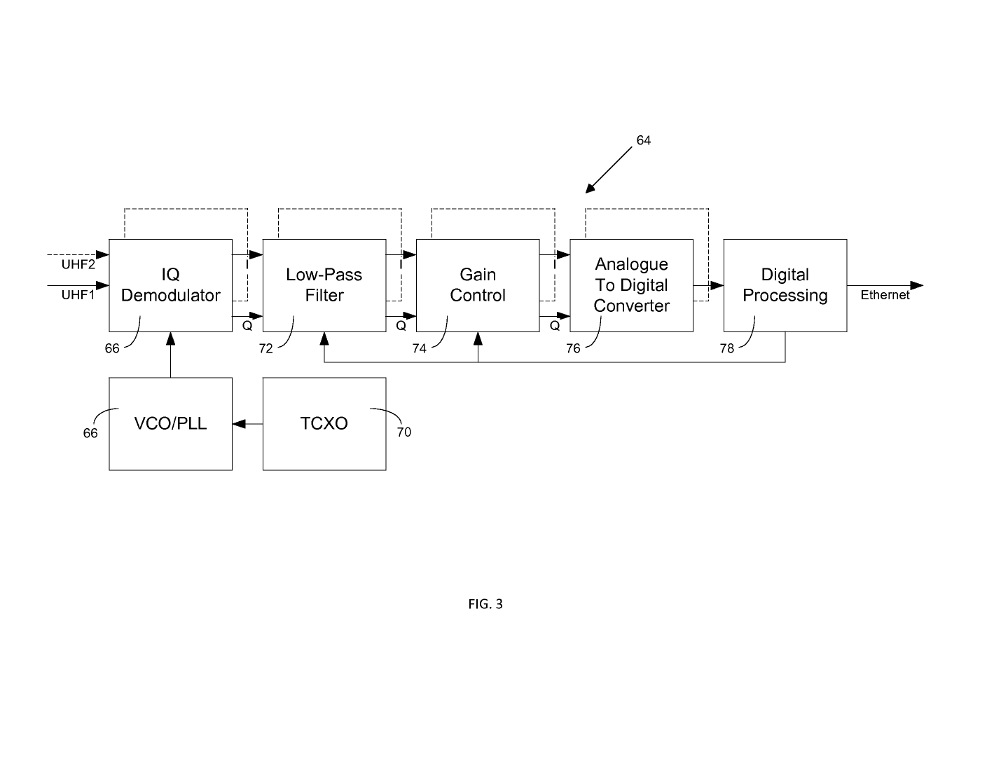

The dual diversity down-converter 38 is usually located within ˜200 m of the wireless microphone transmitter and effectively forms a receive point for the wireless microphone system. Multiple dual-diversity down-converter units can be deployed to form a network and provide wider area coverage. When used in a UHF distribution system, the diversity down-converters may be powered via the UHF distribution cable to avoid the need for remote power. UHF distribution is provided to allow the use of existing UHF based analog audio infrastructure and to be compatible with wireless video systems.

Where UHF distribution is not used, a UHF receiver block 64 shown in FIG. 3 can be docked to the down-converter in order to provide an ethernet based interface. In the UHF receiver block, an IQ demodulator 66 performs a direct down-conversion of the UHF signals to baseband. The IQ demodulator 66 is driven by a VCO/PLL combination 68 that is phase locked to a TCXO 70. The VCO/PLL operates at twice the incoming frequencies. The IQ baseband signal which includes audio data from multiple wireless microphones is filtered by a filter 72 and delivered to a gain control device 74 which applies gain to optimize the IQ level presented to the analog-to-digital converter (ADC) 76. The output of the ADC passes through a digital processing block 78 where the data is converted to an internet protocol (IP) compliant format.

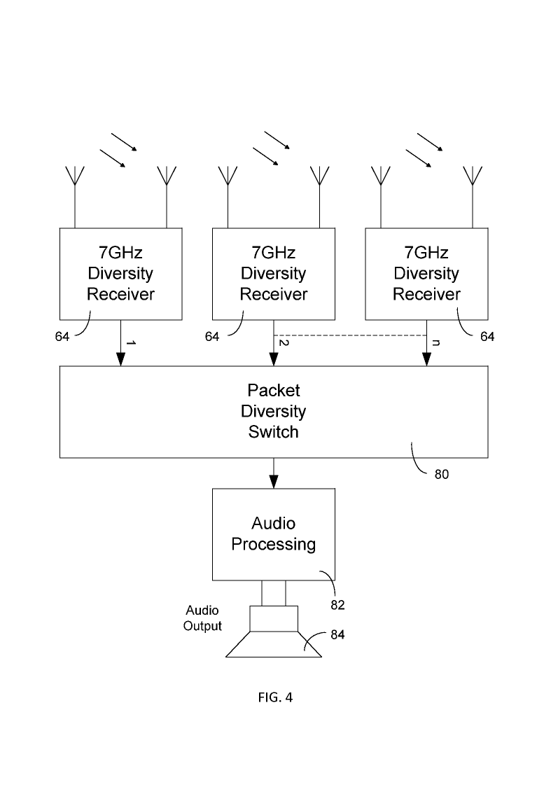

As shown in FIG. 4, the resultant IP packets from n receive locations 64 are distributed to a packet diversity switch 80 where packet diversity is applied. The multiple receive locations are used to provide wide area coverage. Each of the receive locations, through the use of standard error checking techniques, identifies the integrity of the received digital audio information and accordingly marks which audio data packets are valid. The packet diversity switch, usually located within a broadcast production area, selects only valid data packets from each of the audio steams arriving from the different receive locations. The resulting signal is delivered to an audio processor 82 which reconstructs the audio information into an appropriate format for integration within standard audio broadcast infrastructure and produces an audio output 84.

While the preferred forms and embodiments of the invention have been illustrated and described, it will become apparent to those of ordinary skill in the art that various changes and modifications may be made without deviating from the inventive concepts set forth above.

What is claimed is:

1. A wireless transmission system for broadcast audio, comprising
(a) an audio signal processor connected with a microphone for processing an audio signal from the microphone;
(b) a voltage controlled oscillator operating in a range between 6 and 8 GHz connected with said audio signal processor for upconverting the audio signal for transmission.

2. A transmission system as defined in claim 1, wherein said audio signal processor comprises at least one of a digital signal processor and an analog signal processor.

3. A transmission system as defined in claim 2, wherein said analog signal processor includes
a gain control device connected with the microphone, a pre-emphasis device connected with said gain control device, and a reference oscillator connected with said pre-emphasis device, and wherein said digital signal processor includes
a digital encoding modulation device connected with the microphone, a digital to analog converter connected with said digital encoding modulation device for producing in-phase and quadrature phase analog audio signals, a reconstruction filter connected with said digital to analog converter for removing alias frequencies from said in-phase and quadrature signals, and an IQ modulation device for combining and modulating the in-phase and quadrature phase signals.

4. A transmission system as defined in claim 2, wherein said audio signal processor comprises a digital signal processor and an audio signal processor, and further comprising a switch connected with the microphone for selecting between said analog and digital signal processors.

5. A transmission system as defined in claim 2, and further comprising an amplifier connected with said voltage controlled oscillator for amplifying said upconverted audio signal.

6. A transmission system as defined in claim 7, and further comprising a filter connected with said amplifier for filtering said upconverted signal.

7. A transmission system as defined in claim 8, and further comprising a directional coupler connected with said filter and a power lever monitor connected with said directional coupler for maintaining a stable transmission power level by adjusting the gain of said amplifier.

8. A transmission system as defined in claim 2, and further comprising at least one down-converter for receiving transmitted upconverted signals and converting them to a UHF spectrum.

9. A transmission system as defined in claim 10, wherein said down-converter includes a local oscillator set at a fixed frequency and a mixer connected with said local oscillator to convert the upconverted signals to UHF.

10. A transmission system as defined in claim 11, and further comprising a receiver connected with said down-converter and including a demodulator which down-converts the UHF signals to baseband.

11. A transmission system as defined in claim 12, wherein said receiver further includes a phase locked voltage controlled oscillator for driving said demodulator.

12. A transmission system as defined in claim 13, wherein said receiver further includes a digital processor which converts the baseband signals to an internet protocol compliant format.

13. A transmission system as defined in claim 14, and further comprising a plurality of receivers and a packet diversity switch connected with said receivers for applying packet diversity to the received signals in order to provide extended wireless coverage.

14. A method for wireless transmission of broadcast audio, comprises the steps of
(a) processing an audio signal from a microphone; and
(b) upconverting the audio signal to a frequency range between 6 and 8 GHz for transmission.

15. A method as defined in claim 16, wherein said audio processing step comprises at least one of digital and analog processing, and further comprising the step of amplifying said upconverted signal.

16. A method as defined in claim 17, and further comprising the step of filtering said upconverted signal.

17. A method as defined in claim 18, and further comprising the step of adjusting the gain of said amplifier in accordance with a power level of said upconverted signal.

18. A method as defined in claim 19, and further comprising the step of converting said upconverted signal to UHF for integration with UHF distribution infrastructure for wireless video systems.

19. A method as defined in claim 19, and further comprising the step of receiving a plurality of upconverted signals at spaced locations to form a network having spacial diversity and immunity to channel fading.

20. A method as defined in claim 21, and further comprising the steps of converting said upconverted signals to an internet protocol compliant format and applying packet diversity to said signals to provide extended wireless coverage.
